(19) United States
(12) Patent Application Publication
(10) Pub. No.: US 2017/0241405 A1
(43) Pub. Date: Aug. 24, 2017

(54) TURBINE OVER-RATING USING TURBULENCE PREDICTION

(71) Applicant: VESTAS WIND SYSTEMS A/S, Aarhus N (DK)

(72) Inventors: Thomas KRÜGER, Aarhus C (DK); Fabio CAPONETTI, Aarhus C (DK)

(21) Appl. No.: 15/504,115

(22) PCT Filed: Jul. 24, 2015
(86) PCT No.: PCT/DK2015/050226

§ 371 Date: Feb. 15, 2017

(30) Foreign Application Priority Data
Aug. 15, 2014 (DK) PA 2014 70490

(51) Int. Cl. F03D 7/02; F03D 7/04; G05B 19/048; F03D 1/06

(52) U.S. Cl. CPC F03D 7/0268; F03D 1/06; F03D 7/028; F03D 7/047; G05B 19/048; F05B 2220/706; G05B 2219/2619

(57) ABSTRACT

An apparatus and method is disclosed for over-rating a wind turbine using turbulence prediction. Weather forecast information is used to determine whether there is a risk of turbulent conditions occurring at the site of the wind turbine. The wind turbine is over-rated if turbulent conditions are not predicted, and conversely over-rating is cancelled or reduced if turbulent conditions are expected. This allows an increase in the annual energy production of the wind turbine to be realised. The weather forecast information may be combined with real time measurements of operating conditions to supplement the predictions.

This invention relates to over-rating a wind turbine using turbulence prediction. In particular, the invention relates to over-rating control of wind turbines, and to methods and apparatus which enable one or more wind turbines of a wind power plant to transiently generate power in an over-rated operation depending upon the predicted and current turbulence.

The rated power of a wind turbine is defined in IEC 61400 as the maximum continuous electrical power output which a wind turbine is designed to achieve under normal operating and external conditions. Large commercial wind turbines are generally designed for a lifetime of 20 years and their rated power output takes into account that lifespan.

Running a wind turbine in an over-rated mode of operation is desirable because it provides an increase in the annual energy production (AEP) of the turbine. In other words, more energy can be generated over a year than if the turbine were operated without over-rating.

However, over-rating can be dangerous if extreme loads are exerted on the turbine blades by the wind, for example arising from turbulent wind conditions, while the turbine is operated in an over-rated mode. This is because these extreme loads may result in damage to the wind turbine. Over-rating can also mean that the turbine may need increased maintenance, possibly requiring the turbine to be shut down while an engineer is on site. Shutting a wind turbine down places a greater burden on the remaining turbines in the plant to meet the target power output of the plant at that time, and means that the expected increase in AEP is not realised. Maintenance can also be difficult and expensive as the turbines may be in inaccessible locations. It is therefore beneficial to control the extent to which each wind turbine is over-rated, balancing the need to meet power output demands with the drawbacks outlined above.

Further considerations may be important in deciding how much to over-rate each wind turbine. For example, known control systems measure the wind speed at the position of the turbine using an anemometer and place an upper limit on the amount of over-rated power to be generated. This is because it is not safe to run a turbine in an over-rated mode during periods of high wind speed, as there is an increased risk of damage to the turbine as a result of the high forces applied to it by the wind. Therefore such systems are designed to limit the power production during periods of high wind speed at the turbine.

Wind turbines are capable of protecting themselves from damage due to high wind speeds by, for example, varying the pitch of the blades to reduce the power extracted from the wind. In extreme cases the turbine may shut down to prevent catastrophic damage.

However, an emergency shutdown procedure takes time and, in some circumstances, may not be able to prevent severe damage to turbine components from occurring.

We have appreciated that it is desirable to run a wind turbine in an over-rated mode of operation when operating conditions permit. It is possible to monitor parameter values which could indicate that damage may occur to the turbine, in particular extreme loading due to turbulent wind conditions, and only run the wind turbine in an over-rated mode of operation when the risk of such conditions occurring is likely to be low. Thus, a turbine may be run in an over-rated operation if the wind is considered to be coherent with little turbulence.

### SUMMARY OF THE INVENTION

The invention is defined in the independent claims to which reference should now be made. Advantageous features are set out in the dependent claims.

The present invention relates to a wind turbine having a rated power output and an over-rated mode of operation during which one or more operating parameters are adjusted to control the wind turbine to generate power greater than the rated power, the wind turbine comprising a controller for controlling the extent to which the wind turbine is run in the over-rated mode; wherein the controller is operable to receive weather forecast information, and to determine if the weather forecast information indicates turbulent operating conditions; wherein the controller controls the wind turbine to operate in the over-rated mode of operation by adjusting at least one of the operating parameters when the determination does not indicate turbulent conditions; and wherein the controller reduces the extent to which the wind turbine is run in the over-rated mode by adjusting at least one of the operating parameters when the determination indicates turbulent conditions. Weather forecast information may therefore be used by the controller to alert it to the possibility of turbulent operating conditions occurring, and action can be taken to avoid potential damage to the turbine. This allows an increase in annual energy production to be realised because the wind turbine can be over-rated during non-turbulent conditions. The controller may cancel the over-rating when the determination indicates turbulent conditions, in order to avoid damaging the turbine by running it too aggressively.

The controller may operate such that the reduction in the extent to which the wind turbine is run in the over-rated mode increases the clearance between the tower and blades of the wind turbine.

The controller may operate to cancel the over-rating mode when the determination indicates turbulent conditions.

The operating parameter may be one or more of the angular speed of the wind turbine rotor, the pitch angle of the wind turbine blades, or the thrust exerted by the wind on the wind turbine blades.

In controlling these parameters, the controller may communicate an operating parameter set point to the wind turbine.

The controller may be a power plant controller.

The controller may further use historical weather information in determining the extent to which the wind turbine is operated at an over-rated power, as such information will contain trends and information as to the specific operating conditions at the wind turbine site.

The weather forecast information and/or historical weather information may be combined with data from a sensing apparatus in the determination of turbulent conditions, in order to obtain more accurate and more reliable information relating to the operating conditions.

The sensing apparatus may be located remotely from the wind turbine to allow data upwind of the turbine to be used in determining the operating conditions.

The sensing apparatus may be a LIDAR apparatus, as such instruments are well suited to determining wind speed information.

The sensing apparatus may be switched off or switched into a standby mode when the weather forecast information does not indicate turbulent conditions, in order to reduce energy consumption of the apparatus.

The weather forecast information, the historical weather information, and/or the data from a sensing apparatus may include current, past, or predicted future values for one or more of: wind speed, wind turbulence, wind direction, vertical wind shear, horizontal wind shear, air temperature, humidity, and barometric pressure. Such parameters are useful in determining whether turbulent conditions are likely.

The controller may receive the weather forecast information and/or the data from the sensing apparatus periodically, to allow up to date information to be used by the controller.

The controller may wait for a predetermined amount of time after having reduced the extent to which the wind turbine is operated at an over-rated power, thereby allowing time for any turbulent regions of air to pass by the wind turbine.

In further aspects of the invention, methods and a computer readable medium containing one or more executable instructions corresponding to the above are also provided.

### BRIEF DESCRIPTION OF THE DRAWINGS

Embodiments of the invention will now be described, by way of example only, and with reference to the accompanying drawings, in which:

FIG. 1 is a schematic view of a wind turbine nacelle;

FIG. 2 shows a power curve for a wind turbine illustrating over-rating;

FIG. 3 is a schematic illustration of a wind turbine pitch angle and generator speed control system;

FIG. 4 is a schematic illustration of a thrust limiter;

FIG. 5 illustrates the relationship between thrust and wind speed with a thrust limit imposed;

FIG. 6 illustrates the relationship between thrust and wind speed in conservative and over-rated modes of wind turbine operation;

FIG. 7 illustrates the relationship between blade pitch angle and wind speed in conservative and optimal modes of wind turbine operation;

FIG. 8 illustrates an example time-dependence for the angular speed of a wind turbine rotor during high turbulence;

FIG. 9 illustrates an example time-dependence for the angular speed of a wind turbine rotor during low turbulence, in an over-rated mode of operation;

FIG. 10 shows how a ranging wind speed measuring device may be used to measure an extreme operating gust and illustrates tower clearance; and

FIG. 11 is a flow chart illustrating a method of controlling wind turbine over-rating on the basis of weather forecast data.

### DETAILED DESCRIPTION OF EXAMPLE EMBODIMENTS

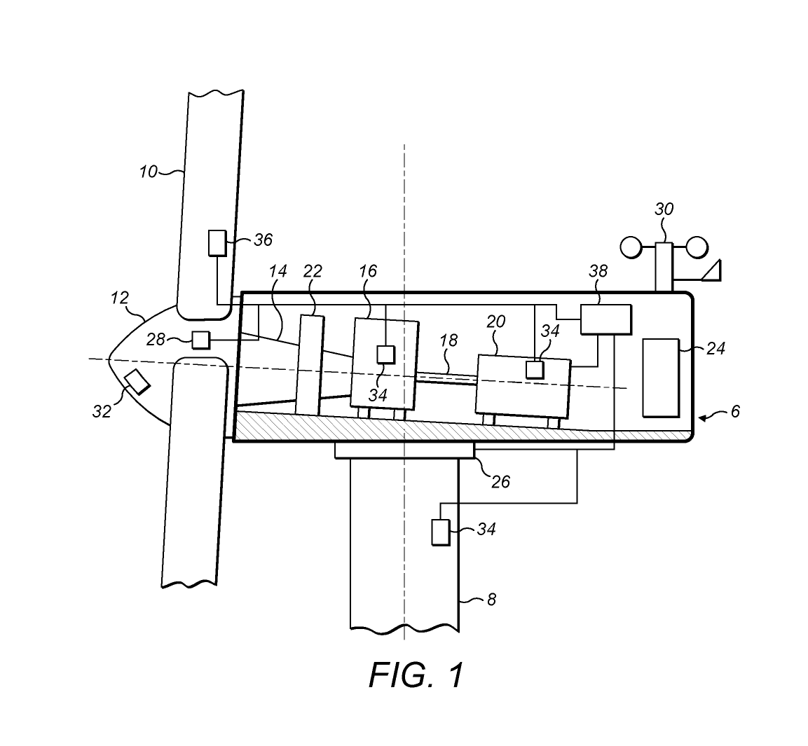

FIG. 1 is an illustration of an example wind turbine nacelle 6 mounted on a tower 8. One or more wind turbine blades 10 are connected to the hub 12, which rotates the main drive shaft 14. The drive shaft is coupled to a gearbox 16, which in turn drives a secondary shaft 18 coupled to the generator 20. The main drive shaft 14 is supported by the main bearing 22. A power convertor and/or transformer 24 may also be housed within the nacelle. Further components include a yaw drive 26 and pitch actuator 28. Sensors 30, 32, 34, and 36 also feed sensor signals to a controller 38. These sensors may include an anemometer and wind vane 30, ranging wind speed measuring device 32 (for example, LIDAR, RADAR, or SODAR), temperature sensor(s) 34, and turbulence monitoring device 36. Turbulent conditions may be detected locally at the wind turbine via both the ranging wind speed measuring device 32 and the turbulence monitoring device 36. The temperature sensor(s) 34 measure(s) the temperature of the key components, for example the gearbox 16 and/or generator 20, as well as the air temperature both inside and outside the nacelle.

The ranging wind speed measuring device 32 is shown in FIG. 1 as being mounted on the hub 12, but its position may vary. For example, it may be mounted on the tower 8, on the top of the nacelle 6, on the underside of the nacelle 6, or in the blades 10. In the latter case, a separate ranging wind speed measuring device 32 may be mounted on each blade or a single device in only one or two of the blades. A single blade may have more than one device.

Turbulence monitoring device 36, such as a load sensor, may be provided on the blade to monitor changes in the bending forces acting within it. Turbulent winds tend to apply rapidly varying forces to the blades, and the effect of these forces in moving the blade is detected by the device 36. Local detection of turbulent conditions may therefore be carried out in real time using the turbulence measuring device to detect changing loads on the blade. The turbulence monitoring device 36 may also include other sensors, such as accelerometers, or displacement sensors to determine the angular speed of the rotor shaft, and/or the pitch angle of the rotor blades.

The controller 38 is responsible for controlling the components described above, and for the operation of the wind turbine generator. Controller 38 may therefore include one or more routines that variously adjust the pitch of the wind turbine blades, control the operation of the generator, control the yaw of the turbine, and activate safety functions depending on the environmental and operational conditions sensed by the sensors. This description of control functions is not intended to be limiting. In this example, the controller 38 also operates as an over-rating controller that causes the generator to transiently produce power in excess of its rated value.

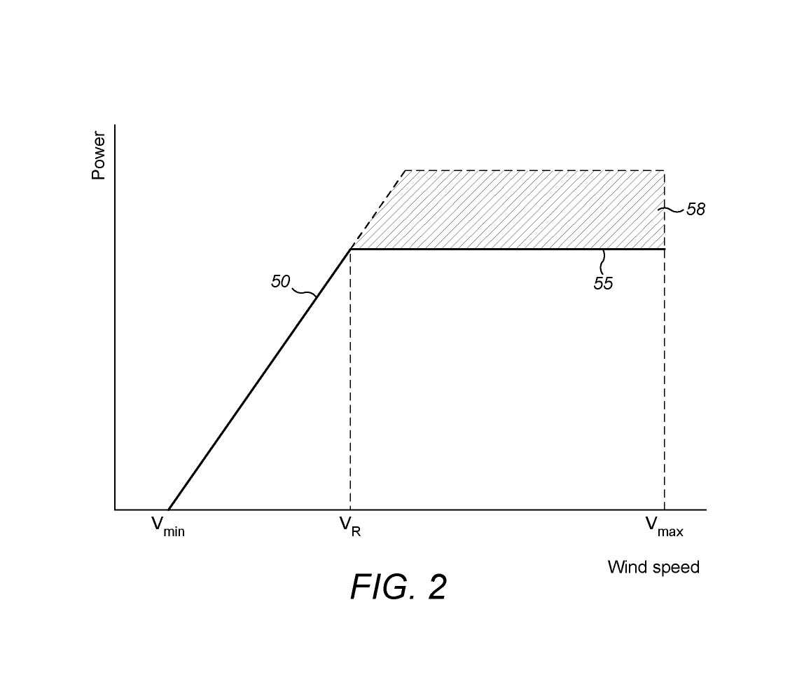

FIG. 2 shows the power curve 50 for a conventional wind turbine. In the figure, wind speed is plotted on the x-axis against power output on the y-axis. Curve 50 is the normal power curve for the wind turbine and plots the power output by the wind turbine generator as a function of wind speed. Note that the power curve shown in the figure is provided for illustrative processes only. It has been simplified compared to the actual data that would be obtained from a wind turbine during operation, which would be expected to show cubic behaviour at low wind speeds, and flatten out towards the rated wind speed.

As is well known in the art, the wind turbine starts to generate power at a cut-in wind speed vₘᵢₙ. The turbine then operates under part load (also known as partial load) conditions until the rated wind speed, v_{R}, is reached. At or above the rated wind speed v_{R}, the rated nominal generator power is reached and the turbine is operating under full load as shown by the line 55. In a typical wind turbine the cut-in wind speed vₘᵢₙ, is 3 m/s and the rated wind speed v_{R} is 12 m/s. The wind speed vₘₐₓ is the cut-out wind speed which is the highest wind speed at which the turbine may be operated safely. At wind speeds equal to and above the cut-out wind speed, the wind turbine is shut down for safety reasons, in particular so that the load acting on the wind turbine is reduced.

As shown in FIG. 2, the wind turbine may be controlled such that it can produce more power than the rated power as indicated by the shaded region 58. When operated in this region, the turbine is ‘over-rated’ which is understood to mean that it is producing more than the rated power whilst being operated under full load. When the turbine is over-rated the turbine is run more aggressively than normal and the generator has a power output which is higher than the rated power for a given wind speed.

Although over-rating is usually characterised by transient behaviour, we have appreciated that a turbine may be over-rated for an extended period of time if the wind conditions are favourable to over-rating. Thus, if the wind conditions are not turbulent and the risk of an extreme event occurring is low, it is safe to run the wind turbine in an over-rated mode of operation until the wind conditions change. The power obtained when running the turbine in an over-rated mode may be up to 30% above the rated power output. Thus, a significant enhancement in the AEP of each wind turbine, in the region of 2% to 5%, may be obtained if the turbines are allowed to operate in an over-rated mode.

The control of a wind turbine to run in an over-rated mode of operation relies on the values of the appropriate operating variables falling within established safe ranges. If the wind speed detected by the ranging wind speed measuring device 32 or predicted in a weather forecast becomes too high for example, it will no longer be possible to operate the wind turbine without potentially damaging the components. To avoid such situations, the over-rating controller 38 therefore receives sensor signals from the one or more sensors 30 and 32, compares these with values stored in memory, and takes action to control the blade pitch angles and/or the generator as appropriate.

The present example of the invention contemplates controlling a wind turbine generator to operate in an over-rated mode to thereby produce more power. Furthermore, switching between the over-rated mode of operation and a normal or non-over-rated mode of operation is based on weather forecast information received at the turbine indicating safe wind conditions. In this context, safe conditions means that the weather information indicates an absence of turbulence in the wind field, and the absence of wind speeds indicative of extreme events.

Over-rating of a wind turbine can be achieved in a number of ways, though it is will be sufficient for the present discussion to focus on pitch control and generator speed control as two particular ways in which the over-rating can be put into effect. Other techniques for over-rating are possible. Controlling the pitch of the wind turbine blades is also typically carried out with regard to the thrust experienced by the blade, and the desired clearance between the wind turbine blades and the tower as the blades pass. The thrust exerted on the wind turbine blades will generally be high if the turbine is generating power above its rated value and/or operating with a rotor speed above the rated speed for the turbine. Thus, the present example also considers how to maintain a suitable tower clearance, that is a suitable minimum distance between the blades and the tower, while allowing over-rating to occur.

For a wind turbine yawed into the wind, the thrust will be substantially parallel to the axial direction of the turbine. In response to the thrust, the wind turbine blades will naturally tend to deflect towards the tower thereby reducing the tower clearance. The tower clearance is likely to be especially reduced at or close to the blade tips where the thickness of the blades is less, and the blades are more susceptible to deformation, and additionally because this part of the blade passes closer to the base of the tower where the tower may have a larger diameter. Typically, it is desirable to maintain a minimum a tower clearance of 4 m for safe operation of the wind turbine, although this value can vary with the specific model of wind turbine being used.

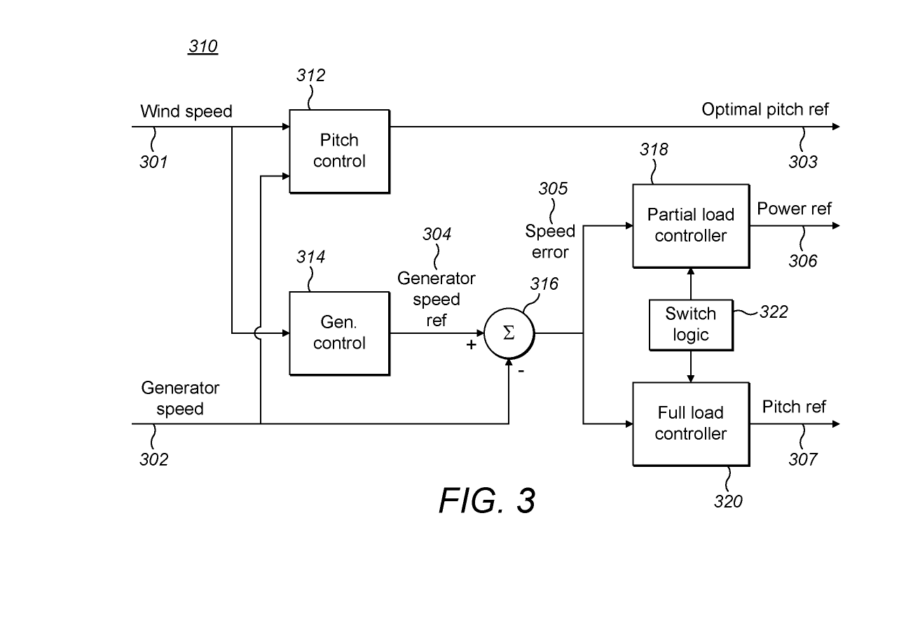

FIG. 3 is a schematic illustration of a wind turbine blade pitch and generator speed controller 310. The controller 310 may be implemented as part of general wind turbine controller 38, and includes pitch control module 312 and generator speed control module 314 for calculating the optimal pitch angle and optimal generator speed based on one or more respective input parameters.

The controller 310 queries a wind speed measuring device, for example the anemometer 30, to obtain a value of the wind speed 301. Controller 310 also queries sensors on the generator 20 to obtain the generator speed 302. Both the wind speed 301 and generator speed 302 are input into pitch control module 312. The wind speed 301 is input into generator speed control module 314.

Pitch control module 312 is responsible for calculating an optimal pitch reference 303, which is then output to further control stages, and ultimately one or more pitch actuators for controlling the wind turbine blades. In one example, the pitch control module 312 may refer to one or more pitch control curves 700 and/or 702 (see FIG. 7) to obtain a suitable value for the blade pitch angle for a given wind speed. The optimal pitch reference 303 is determined so as to maximise power delivery by the generator.

Generator speed control module 304 is responsible for calculating the optimal generator speed for a given wind speed. This optimal speed is output as a generator speed reference signal 304, which is compared against the actual generator speed 302 in comparator 316. The difference between these two quantities gives a speed error signal 305 which is fed into partial load controller 318 and full load controller 320. Whether the partial load controller 318 or full load controller 320 is used will depend on the switching logic 322 which switches between the two controllers according to the operating conditions of the wind turbine.

When the wind turbine is operating under partial load, for example when operating on the line 50 of the power curve shown in FIG. 2, switch logic 322 enables the partial load controller 87, and the partial load controller outputs a power reference 306. This power reference 306 is then fed back to the wind turbine controller 38 to allow it to make adjustments to the wind turbine components, for example to the generator torque via a current demand signal, such that the power generated by the wind turbine tends towards the power reference 306.

When the wind turbine is operating under full load, for example when operating on the line 55 or within the over-rated region 58 of the power curve shown in FIG. 2, switch logic 322 enables the full load controller 320, and the full load controller outputs a pitch reference 307. This pitch reference is then transmitted to the blade pitch actuator 28 to execute any necessary changes to the pitch of the blades.

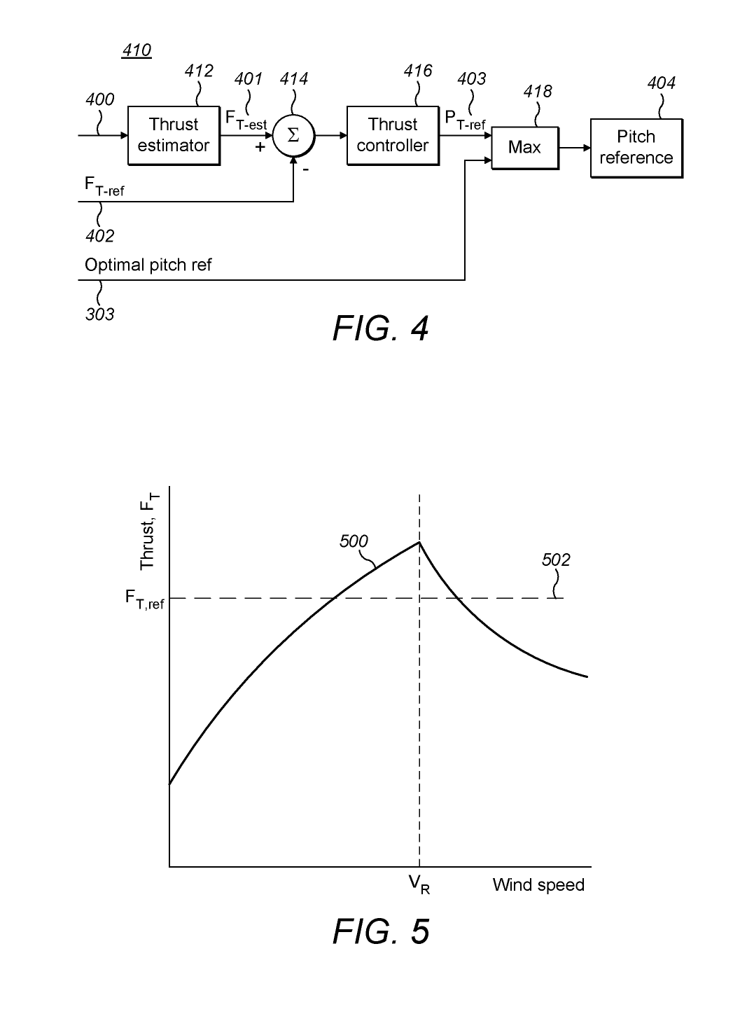

FIG. 4 is a schematic illustration of a thrust limiter 410. The thrust limiter 410 may be implemented as part of the general wind turbine controller 38. Thrust limiter 410 comprises thrust estimator control block 412, which receives one more input data 400 from wind turbine sensors. Such input data 400 may include one or more of the wind speed, the blade pitch angle, and blade loads for example. On the basis of these data, the thrust estimator 412 determines an estimated value for the thrust experience by the blades as a result of the incident wind. This value, F_{T-est} 401 is output and fed into comparator block 414, where it is compared against a thrust reference value, F_{T-ref} 402, which is a predetermined thrust value above which it is undesirable for the thrust to increase. This predetermined thrust value can be set in order to maintain a certain minimum tower clearance for example.

The difference between the estimated thrust F_{T-est} 401 and the thrust reference F_{T-ref} 402 is output by comparator block 414 and input into thrust controller 416. If the estimated thrust F_{T-est} 401 is greater than the thrust reference F_{T-ref} 402 the thrust controller 416 calculates a pitch angle P_{T-ref} 403 at which the blades should be pitched to reduce the thrust to an acceptable value not exceeding the thrust reference F_{T-ret} 402. To do this the thrust controller 416 uses the difference signal between F_{T-est} 401 and F_{T-ref} 402 together with any other necessary data.

Maximum Selector Block 418 receives as an input the pitch angle reference signal P_{T-ref} 403 calculated and output by the thrust controller 416, as well as optimal pitch reference 303 calculated by pitch angle control module 312. Optimal pitch reference 303 is the energy-optimal pitch angle, to which the blades should be set in order for the turbine to generate energy most efficiently from the wind. Maximum Selector Block 418 compares the pitch reference signal P_{T-ref} 403 from thrust controller 416 to the optimal pitch reference 303 and selects the maximum of these two quantities. As discussed in more detail below, a larger pitch angle will be understood to corresponds to a blade position that is more pitched out of the wind than a lower pitch angle. The selected output from maximum selector block 418 is then output to one or more pitch actuators to control the angle of the blade.

As a consequence of the maximum selector block 418, the output pitch reference 404 used can never be lower than the optimal pitch reference, but it may be higher if the thrust controller 110 requires a suitably high pitch reference in order to reduce the thrust on the blades.

FIG. 5 illustrates the effect of controlling the thrust in accordance with the thrust limiter illustrated in FIG. 4. In FIG. 5, line 500 is a plot of the thrust force F_{T} against the wind speed, without thrust limiter control being applied. The thrust force increases with increasing wind speed up to a maximum thrust force which occurs at the rated wind speed V_{R}. The thrust force then decreases with further increasing wind speed above the rated wind speed, as the blades are pitched to reduce the force from the wind. Line 502 shows the position of the thrust reference F_{T,ref}. When the thrust limiter control process of FIG. 4 is in operation, the thrust experienced by the blade is constrained to lie on the curve 502. Thus the peak in the thrust force that occurs close to the rated wind speed is flattened out, preventing the thrust force from becoming excessively high and ensuring that a suitable tower clearance is maintained.

Although in this example the thrust is controlled by pitching the blades, in other embodiments the thrust may be controlled by adjusting the rotor speed or generator speed as explained below.

The operation of an example embodiment of the invention will now be described with reference to the control curves of FIGS. 5, 6, 7, 8 and 9. In each case, the controller of the wind turbine determines from the weather information if turbulent or extreme wind conditions are expected. If extreme wind conditions are not expected, the control switches to an over-rating mode in which the control or operating parameters of the wind turbine are set to extract more power from the incident wind. If turbulent or extreme wind conditions are expected then the wind turbine controller switches to safe mode operation in which the over-rating is effectively cancelled. The weather information received by the wind turbine controller will typically allow decisions about the control scheme of the wind turbine to be carried out on at least an hour by hour basis.

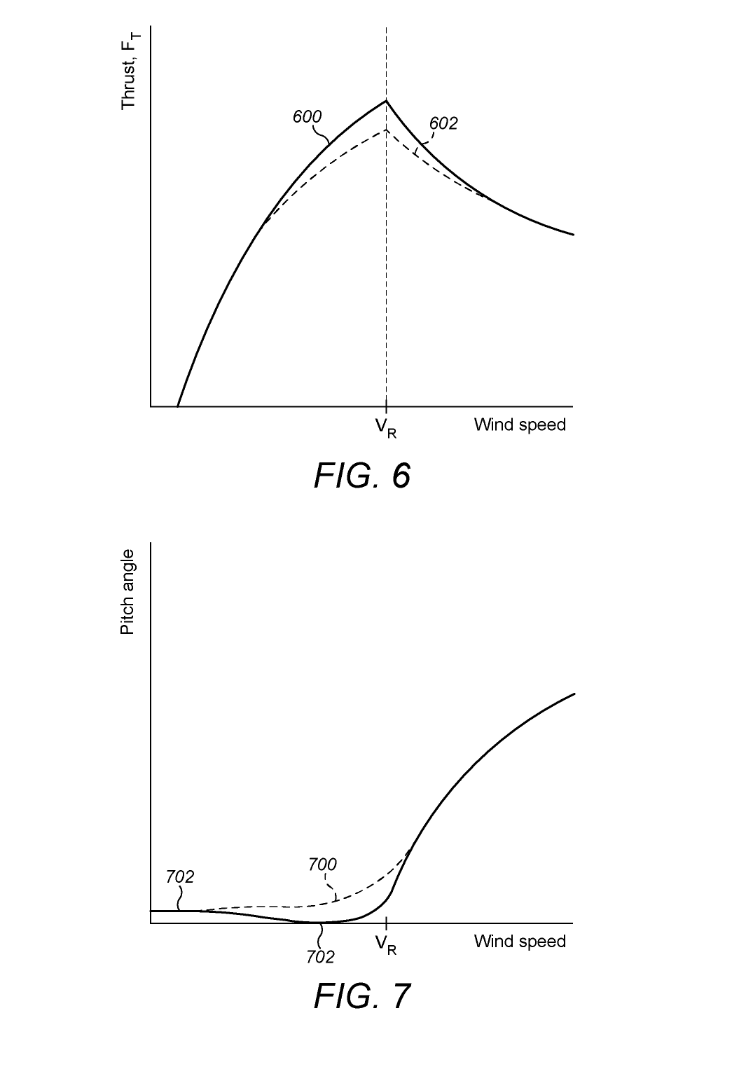

FIG. 5 is a thrust curve illustrating the relationship between the speed of the incident wind and the associated thrust force F_{T} experienced by the wind turbine blades. As noted above, at the rated wind speed, V_{R}, the thrust value F_{T} reaches its maximum value. Below V_{R} the thrust is less than the maximum due to the lower speed of the incident wind. Above V_{R}, the thrust falls away as the wind turbine blades are usually controlled to pitch them out of the wind. The thrust curves shown in FIG. 6 may be used by the thrust limiter of FIG. 4 in determining the maximum allowable thrust experienced by the blade for each given wind speed. This is to ensure that the blades remain operating within desired loads and ensures that the clearance between the tower and the blades is maintained. The thrust controller may be part of the wind turbine controller 38. The thrust experienced by the blade can be controlled by varying the blade pitch.

In a first mode of operation, over-rating is applied to the operation of the thrust limiter 410. The thrust limiter operates to maintain a particular clearance distance between the blades and the tower, as the blades pass by the tower at the bottom of their rotation. The tower clearance is maintained by limiting the pitch angle in the manner described above in connection with FIG. 4.

The tower clearance does not take into account the weather conditions at the wind turbine, and so has to be configured to allow for the possibility of an extreme gust occurring at the wind turbine. This means that the tower clearance is configured to be greater than is necessary for normal operation of the wind turbine, and as a result the pitch control is unduly constrained during normal operation. In a first embodiment, therefore the controller allows a smaller tower clearance for the wind turbine blades, when the weather information does not indicate turbulent conditions. This can be achieved by adjusting the thrust reference F_{T-ref} 502 shown in FIG. 5 to a higher value during a period of over-rating, corresponding to a smaller tower clearance. If turbulent conditions are again indicated by the weather information, the controller cancels over-rating, and the thrust reference F_{T-ref} 502 reverts to a more conservative value.

Similarly, FIGS. 6 and 7 show the thrust curves and the associated pitch control curves for an over-rated mode of operation 600 and 700 and a more conservative 602 and 702 or non-over-rated mode of operation. As before, in the second embodiment, the wind turbine controller switches between the two modes of operation based on the weather information. If the weather information indicates that weather and wind conditions are safe, that is no turbulence or extreme gusts are predicted, the controller operates the wind turbine according to the pitch control curve 702. If the weather information indicates that turbulence or extreme wind gusts are expected, then the controller switches to the conservative mode 700 of operation. The associated thrust experienced by the blades is shown in FIG. 6.

FIG. 6 assumes that a thrust limiter operation is not applied or is not required. The thrust limiter operation of FIGS. 4 and 5 may however also operate in conjunction with the control of FIGS. 6 and 7.

The difference in pitch angle between the over-rated mode of operation illustrated by line 700 and the mode in which the over-rating is cancelled illustrated by line 702 is in the range of 0° to 5°, and preferably is in the range of 2° to 3°.

As illustrated in FIG. 7, the pitch angle may be a non-zero, positive value. However, the pitch angle can be defined relative to any appropriate reference point. For example, the actual pitch reference signal can be defined in a number of ways. In general, the pitch angle may be defined as the geometrical angle between a chord of the blade profile and the rotor plane at a given radius. Here, the pitch angle may therefore be the angle of the blade tip with reference to the rotor plane. Other locations on the blade surface will have potentially different angles of attack due to the twist in the blade from the tip to the root. Selecting the location on the blade span where the pitch angle is defined is merely a matter of convention. Typically, the pitch angle is between −5 degrees and +5 degrees in partial load operation, and rises to 30 degrees or more in full load operation. The pitch angle may be higher than this in high winds, for example wind speeds in excess of 25 m/s.

In this example, a zero degree pitch angle corresponds to pitching the wind turbine blade into the wind to extract the maximum amount of energy from the incident wind. In this configuration, the blades' pressure and suction surfaces are positioned to experience maximum lift from the wind, and therefore any associated loading force of the wind. In strong wind conditions, the wind turbine blades are feathered, or angled out of the wind, thereby reducing the loads on the blades. This corresponds to an increasingly positive pitch angle, as shown in FIG. 7 at high wind speeds.

The lower pitch angle shown in FIG. 7 results in a higher power coefficient C_{P}, defined as the relative amount of energy extracted from the wind. A plot of C_{P} against tip-speed ratio is a front loaded peak with a long tail. For a given tip-speed ratio, the peak gets smaller as the pitch angle is increased.

In turbulent conditions, the thrust load exerted on the blades by the wind may momentarily increase before the thrust limiter has time to react and reduce the thrust by pitching the blades out of the wind. If the wind turbine is operating in an aggressive mode of operation, such as the over-rated mode of operation illustrated by the line 702 when such a weather event occurs, there is a possibility that the thrust will become high enough to compromise the tower clearance. It is therefore desirable, if turbulent conditions are predicted or measured, to limit the thrust in accordance with operating curve 700 corresponding to a cancellation of the over-rated mode of operation. This ensures that the thrust cannot increase to such an extent that the tower clearance is compromised by the turbulent conditions.

In a third embodiment of the invention, over-rating of the rotational speed ω_{g} of the generator is carried out based on the weather information. The rotational speed of the generator is typically measured in revolutions per minute (R.P.M.) over time, and with relation to a shutdown threshold. Above the cut-in wind speed vₘᵢₙ (see FIG. 2), the wind turbine controller 38 gradually ramps up the generator speed ω_{g} with increasing wind speed until the maximum rated generator speed is reached. This occurs just before the rated wind speed. As the generator speed is being ramped up, the turbine can be controlled to have an optimum tip speed ratio for the incident wind, and the generator speed follows the wind speed in an approximately linear relationship. Such control can be obtained by varying the pitch of the blades for example. The wind turbine extracts the maximum power from the wind as the controller provides optimal pitch and power references, but produces a power output that is below the rated power.

The wind speed at which the controller sends a maximum permitted generator speed reference to the generator occurs slightly earlier than the rated wind speed. Once this occurs, the turbine cannot be controlled to optimum speed, because the generator speed would otherwise become too high. In this case, therefore, efficiency is maintained by operating the turbine at its upper speed limit. The pitch angle is still controlled to the optimal value.

Above the rated wind speed, the controller controls the generator to maintain a constant generator speed and operates in full load. In full load operation, the power reference is kept at the nominal value as the wind speed increases, the controller issues further pitch control signals to the one or more pitch actuators 28 using a collective control algorithm so that more and more wind is spilled from the blades, and the rotational speed of the rotor and generator remain constant at the rated value.

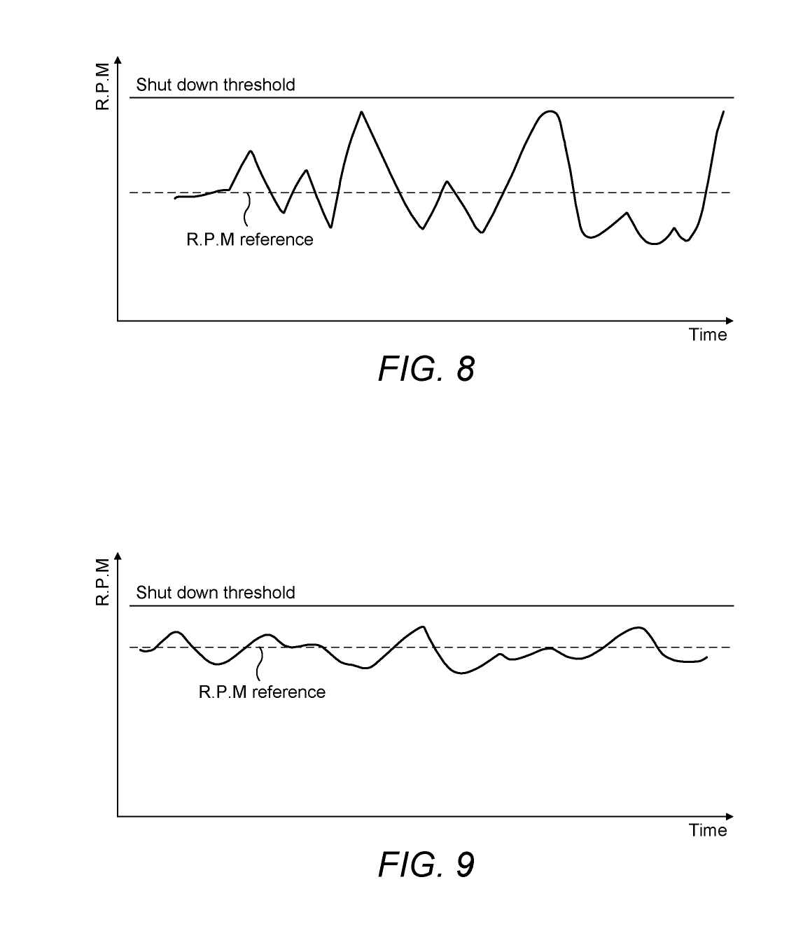

The example plots in FIGS. 8 and 9 show variations in the rotational speed which arise due to changes in the wind conditions. The plots serve to illustrate the variation in rotational speed over a time period of 2 minutes for example, but it will be appreciated that the exact way in which the speed varies over time will depend both on the specific wind turbine in question and the weather conditions during operation.

FIGS. 8 and 9 both indicate an R.P.M. reference, which is a target rotation speed for the generator. In one example, the pitch controller continuously adjusts the pitch of the blades in order to minimise the difference between the actual R.P.M. and the R.P.M. reference, with the result that the R.P.M. tends to fluctuate about the reference value. The actual R.P.M. will momentarily increase above the R.P.M. reference in a period of time when the wind speed increases but before the blade pitching effects a reduction in rotation speed for example. Similarly, the actual R.P.M. will momentarily decrease below the R.P.M. reference in a period of time when the wind speed decreases but before the blade pitching effects an increase in rotation speed.

In other examples, the R.P.M. is controlled by adjusting the generator torque, as an alternative to or as well as adjusting the pitch of the blades.

FIGS. 8 and 9 both also indicate a shutdown threshold, which is the maximum permitted angular speed above which it is not safe to run the wind turbine. This is also known as ω_{cut-out}. If the R.P.M. exceeds the value of the shutdown threshold then the controller takes steps to shut down the wind turbine.

As illustrated in FIG. 8, the generator R.P.M. reference is set to a predetermined value below the shutdown threshold. In this example, the R.P.M. reference is set to a value 20% to 30%, for example 25%, below the value of the shutdown threshold. A typical value of the generator R.P.M. reference may be 1500 revolutions per minute for example. This allows a sufficient margin for the actual R.P.M. to increase above the R.P.M. reference, for example due to turbulent wind conditions, thereby reducing the risk of the R.P.M. exceeding the shutdown threshold.

In FIG. 9, the R.P.M. reference is set between 1% and 5% closer to the shutdown threshold than in FIG. 4A. This mode of operation corresponds to an over-rated mode of operation which may be used when the weather conditions are particularly favourable, with little variation in wind speed and no turbulence. Thus, the illustrated size of the fluctuations in the actual R.P.M. about the R.P.M. reference is smaller than in FIG. 4A, which allows the margin between the R.P.M. reference and the shutdown threshold to be reduced whilst still keeping the risk of the actual R.P.M. exceeding the shutdown threshold at an acceptably low level.

The operation depicted in FIG. 9 is used when it is safe to run the wind turbine in an over-rated mode for example, whereas the operation depicted in FIG. 8 is used when significant variations in the wind speed and/or turbulence are predicted by a weather forecast and it is therefore not safe to run the wind turbine in an over-rated mode. As with the first and second embodiments, the controller may switch between the two modes of operation based on the weather forecast information.

In addition to thrust, pitch and generator speed control signals, in alternative embodiments of the invention, it will be suitable to achieve over-rating based on the power reference signal sent to the generator.

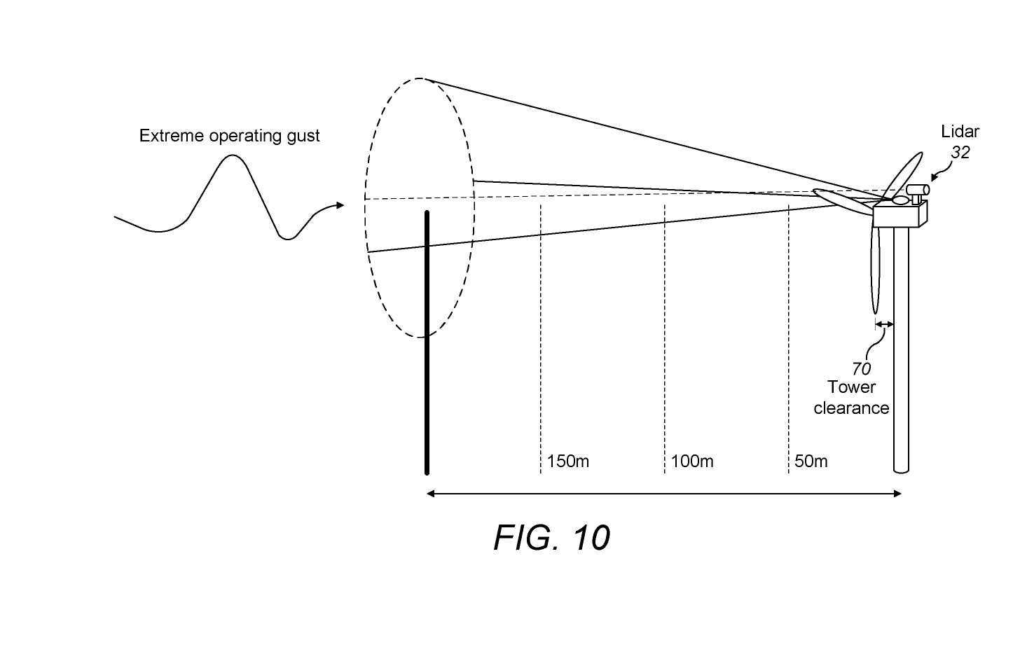

In addition to weather forecast data to predict turbulent wind conditions, it may also be advantageous to use a ranged wind speed measuring device 32 to detect turbulence or extreme operating gusts occurring on a shorter time scale than is possible with a weather forecast, such as those occurring immediately upwind of the turbine. As shown in FIG. 10, in some embodiments the ranging wind speed measuring device 32 is a LIDAR device, operating by emitting a laser beam to measure conditions in a cone-shaped region a distance in front of the turbine. The LIDAR operates in a known manner, either by detecting air molecules or by detecting particles entrained in the airstream and calculating information about the airflow from these measurements. Based on the calculated wind parameters, operational parameters of the wind turbine may be controlled to optimise the amount of energy that can be extracted from the wind. In addition to obtaining information relating to the wind conditions in front of the turbine, for example the amount of turbulence or the presence of an extreme operating gust, by means of ranging wind speed measuring devices 32, it is also desirable to combine this information with longer term weather forecasting information to build a more complete picture of the operating conditions at the location of the wind turbine.

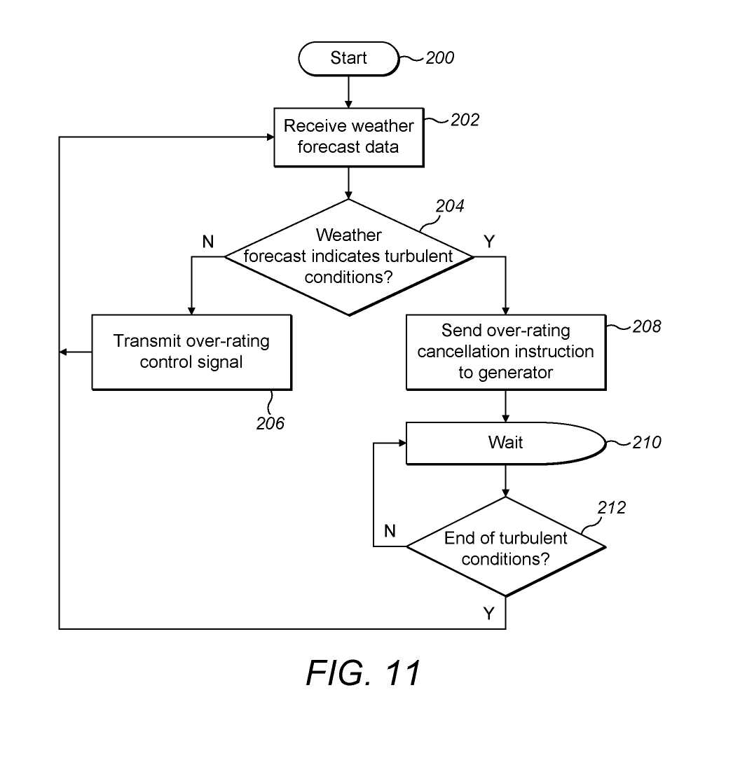

FIG. 11 is a flow chart illustrating the steps taken by a controller in a method for controlling wind turbine over-rating. The method starts at block 200. At block 202 weather forecast data is received by the controller 38. From the weather forecast data, the controller determines the risk of turbulence, and/or optionally the severity of any incoming gusts of wind. Such weather forecast data may therefore include wind speed, wind direction, humidity, air temperature, barometric pressure, risk of abnormal weather, risk of tornados, risk of thunderstorms, risk of extreme gusts, risk of wind direction changes, gust amplitudes, and other relevant information, at the location or in the vicinity of the wind turbine. The weather forecast data may include a dedicated parameter specifying the quality of the wind conditions predicted for the wind turbine location, such as calm or gusty. An indication of gusty wind conditions for example may be taken by the wind turbine controller 38 as indicative of potentially turbulent conditions. The weather forecast data is obtained from a weather forecast data provider. The provider may transmit weather forecast data to the controller 38 via a wired or wireless communications network. The communication network may be private, such as the SCADA data acquisition network, or may be public, such as the internet.

Weather forecast data providers are capable of making predictions as to the weather conditions that will occur at multiple times into the future. For example, current weather forecast data may be available for the next hour, three hours into the future, one day into the future, and one week into the future. It is therefore likely, as time progresses, that the controller will receive and retain in memory multiple weather forecasts relating to a particular given future time. In this case, the controller may weight the weather forecasts generated closer to the given future time more strongly than those which were generated further from that given future time. This is because the accuracy and reliability of weather forecast data tends to increase as the forecast relates to times closer into the future.

At block 204 a decision is made by the controller as to whether or not the weather forecast data indicates turbulent conditions. This decision is made on the basis of the forecast data communicated to the controller, and may take into account how recently the forecasts were made as described in the previous paragraph.

In one embodiment, if the controller decides that turbulent conditions are not indicated or likely on the basis of the forecast data, it proceeds to transmit an over-rating control signal in step 206. As discussed above, the over-rating control signal may be one or more of a thrust limiter control signal, a pitch control signal, or a generator speed control signal. Two or more operating parameters may be controlled simultaneously by the controller for this purpose.

The method then returns to block 202 where a weather forecast data provider is once again queried and the latest weather forecast data is received.

If the controller decides in block 204 that turbulent conditions are indicated or likely, it proceeds to send an over-rating cancellation instruction to the generator in block 208. The wind turbine will then be controlled in order to reduce the amount of power being generated, for example by adjusting the pitch of the blades in order to reduce the speed of rotation, or by reducing torque via a generator current demand signal.

In an alternative embodiment, the block 208 does not simply cancel the over-rating altogether, but further includes the steps of determining new thrust, pitch or generator speed control signals

In a further embodiment, the controller may produce a quasi-static signal representing the risk of an incoming gust, or may produce a multi-dimensional signal containing the characteristics of the turbulence, for example velocity components along three orthogonal axes. The signal may also contain information relating to the quality of the turbulence, for example the time between successive gusts or the maximum difference in wind speed expected at the wind turbine as the turbulent region of air passes by. This signal is then processed in order to determine the extent to which the wind turbine is allowed to run in the over-rated mode of operation, and an appropriate over-rating command is transmitted to the generator.

In extreme cases, when very severe turbulence is predicted, the controller 38 may take steps to shut down the wind turbine rather than cancelling or reducing the over-rated mode of operation.

Once the instruction to cancel or to reduce the over-rated mode of operation has been sent in block 208, the method proceeds to a period of waiting in block 210. The duration of this waiting period will be determined in advance and is related to average length of time required for turbulent conditions to settle down to normal operating conditions. The value of this waiting time will therefore vary depending upon the location of the wind turbine.

In block 212 a decision is made as to whether or not the turbulent conditions have ended. This decision may be made on the basis of real time measurements, for example from ranging wind speed measuring devices 32. Alternatively or in addition to this, the decision may be made on the basis of updated weather forecast data.

If it is decided that turbulent conditions have not ended or are likely to resume within a short time period, the method returns to the waiting stage 210. If it is decided that the turbulent conditions have ended and the operating conditions of the wind turbine have settled to a more normal level, the method returns to block 202 where a weather forecast data provider is once again queried and the latest weather forecast data is received.

In alternative embodiments, at least one of the waiting block 210 and decision block 212 may be absent from the method, and after sending an instruction to cancel or reduce the over-rating in block 208 the method may return directly to receiving the latest weather forecast data in block 202. However, the inclusion of the blocks 210 and 212 may be desirable for safety reasons, as they include the steps of waiting for turbulence to end, and specifically checking that the operating conditions allow the wind turbine to return safely to an over-rated mode of operation after a period of turbulent weather.

In a further embodiment, information regarding real time operating conditions of the wind turbine may also feed into the decision made at block 204. Thus if a LIDAR detector 32 measures turbulent conditions, for a example a rapidly changing wind direction front in advance of the wind turbine, then this information may also be used in the block 204 in order to direct the method to cancel or reduce the over-rating.

In an example, the controller may be set to indicate turbulent conditions if the predicted wind speed for the next hour is due to rise above a predetermined value. This is because turbulence is more likely at higher wind speeds. Thus, if the forecast wind speed data received by the controller in block 202 is below this predetermined value and the LIDAR sensor 32 does not detect wind in advance of the turbine travelling faster than this predetermined value, a decision is made in block 204 that turbulent conditions are not expected.

In an alternative scenario, the wind speed forecast data for the next hour received by the controller in block 202 is still lower than the predetermined value at which turbulent conditions are deemed to become significant. However, now the LIDAR sensor 32 detects a region of wind speed in excess of the predetermined value, the region being located approximately 5 seconds upwind of the turbine. In these circumstances the decision made at block 204 is that turbulent conditions are indicated, and the method goes on to issue an over-rating cancellation instruction in block 208. The over-rated mode of operation is then cancelled. The method waits for a period of time in block 210, for example 10 minutes, to allow any localised regions of high wind speed and turbulence to settle, and then proceeds to block 212. Here a reading is then taken from anemometer 30 to determine if there is still a high wind speed at the location of the turbine. If yes, then the turbulent conditions are deemed to be continuing and the method returns to the waiting block 210. If no, the method returns to obtain the latest weather forecast data in block 202. Other sensed variables may be used to establish if turbulent conditions are present at the turbine location. These may include, for example, rotor speed, blade pitch angle, and the loads on the blades.

In another alternative scenario, the wind speed forecast data received by the controller in block 202 indicate that speeds in excess of the predetermined value are likely to occur at some point within the next hour. The decision made at block 204 is again that turbulent conditions are indicated, and the method proceeds as above to issue an over-rating cancellation instruction in block 208.

This example embodiment illustrates how the weather forecasting data may be used to enable longer term behaviour in the weather, applicable on the order of hours, to be fed into the decision making process. It also shows how shorter term measurements of the operating conditions, which apply on the order of seconds, can be combined with the weather forecast data in order to obtain a full picture of the present and future operating conditions. As explained above, pitch angle, thrust, and output power could also be used as control parameters, as well as or as an alternative to the angular speed of the rotor.

In one embodiment, the LIDAR detector 32 acts to confirm the accuracy of the weather forecast data received in block 202, based on local measurements by the ranging wind speed measuring device or the turbulence monitoring device and if the confirmation is successful the weather forecast data is fed into the decision made in block 204. If the local measurements indicate a discrepancy with the predicted weather forecast, then the weather forecast data is rejected. The principal weather data could be obtained from the LIDAR detector 32, with the received weather forecast information being used to confirm the LIDAR measurements.

If the weather forecast data indicates a zero or very low risk of turbulence occurring, the LIDAR detector may be switched off or placed into a standby mode in order to save power. The LIDAR detector is maintained in this power-saving state until weather forecast data indicates that turbulence may be expected.

In other embodiments, the decision block 204 may also refer to historical weather data in order to further determine whether or not turbulent conditions are indicated. Thus, in one example, whenever a weather forecast for the next hour is received at block 202, the data may be written to a memory and retrieved by the controller at a later time. Alternatively, or in addition to this, the controller may access historical stores of measured and forecast weather data which may be provided at a location remote to the turbine.

By analysing the historical weather data, the controller 38 can make more intelligent use of the weather forecast data received in block 202, together with any ranging wind speed measurements that may be provided, for example by the LIDAR 32. In a simple example, the geographical area in which the turbine is located may have a tendency for turbulent, stormy conditions to arrive sometime after the humidity rises beyond a certain value. Thus, by consideration of the historical weather data, the controller will associate rising humidity with an increased risk of turbulence. Then, when the received weather forecast in block 202 forecasts rising humidity, the wind turbine controller will consider that there is an increased risk of turbulent conditions, and the decision block 204 will direct the method to cancel or reduce the over-rated mode of operation in anticipation of this.

The historical weather data may also be used in determining the waiting time built into the method of the above embodiments at block 210. Thus, the historical data may suggest that, on average, a period of turbulent weather lasts only for 15 minutes at a particular wind turbine location, after which time the operating conditions have returned to normal and it is safe to fully over-rate the turbine. In this example, the waiting time of block 210 may be set to 20 minutes, thereby including a 5 minute safety margin.

Without consulting the historical weather data a shorter or longer waiting time may have been set. A shorter waiting time has the disadvantage that the controller is more likely to test for the end of turbulent conditions in block 212 when turbulent conditions are still ongoing. If the test for turbulent conditions does not indicate that turbulence is expected, for example because of a momentary reduction in wind speed in the middle of an otherwise turbulent storm, the controller will return to the start of the method and may allow the turbine to over-rate. A longer waiting time has the disadvantage that, on average, the turbine is able to return to over-rated power generation sooner than the waiting time provided in the method, and therefore the turbine unnecessarily spends time not generating power in an over-rated mode of operation. This reduces the amount of energy generated by the turbine.

We have therefore appreciated that an increase in the AEP of a wind turbine can be achieved by allowing the turbine to run in an over-rated mode for more of the time. This is due to an improved method for detecting the turbulent conditions which make it unsafe or impractical to over-rate the turbine.

Various modifications to the example embodiments described above are possible and will occur to those skilled in the art without departing from the scope of the invention which is defined by the following claims.

What is claimed is:

1. A wind turbine having a rated power output and an over-rated mode of operation during which one or more operating parameters are adjusted to control the wind turbine to generate power greater than the rated power, the wind turbine comprising a controller for controlling the extent to which the wind turbine is run in the over-rated mode;
wherein the controller is operable to receive weather forecast information, and to determine if the weather forecast information indicates turbulent operating conditions;
wherein the controller controls the wind turbine to operate in the over-rated mode of operation by adjusting at least one of the operating parameters when the determination does not indicate turbulent conditions; and
wherein the controller reduces the extent to which the wind turbine is run in the over-rated mode by adjusting at least one of the operating parameters when the determination indicates turbulent conditions.

2. The wind turbine of claim 1, wherein the reduction in the extent to which the wind turbine is run in the over-rated mode increases the clearance between the tower and blades of the wind turbine.

3. The wind turbine of claim 1, wherein the controller cancels the over-rating mode when the determination indicates turbulent conditions.

4. The wind turbine of claim 1, wherein an operating parameter is the angular speed of the wind turbine rotor.

5. The wind turbine of claim 1, wherein an operating parameter is the pitch angle of the wind turbine blades.

6. The wind turbine of claim 1, wherein an operating parameter is the thrust exerted by the wind on the wind turbine blades.

7. The wind turbine of claim 1 wherein the controller communicates an operating parameter set point to the wind turbine.

8. The wind turbine of claim 1 wherein the controller is a power plant controller.

9. The wind turbine of claim 1 wherein the controller further uses historical weather information in determining the extent to which the wind turbine is run in the over-rated mode.

10. The wind turbine of claim 1 wherein the weather forecast information and/or historical weather information is combined with data from a sensing apparatus in the determination of turbulent conditions.

11. The wind turbine of claim 10 wherein the sensing apparatus is located remotely from the wind turbine.

12. The wind turbine of claim 10 wherein the sensing apparatus is a LIDAR apparatus.

13. The wind turbine of claim 10, wherein the sensing apparatus is switched off or switched into a standby mode when the weather forecast information does not indicate turbulent conditions.

14. The wind turbine of claim 1 wherein the weather forecast information, the historical weather information, and/or the data from a sensing apparatus includes current, past, or predicted future values for one or more of: wind speed, wind turbulence, wind direction, vertical wind shear, horizontal wind shear, air temperature, humidity, barometric pressure, risk of abnormal weather, risk of tornados, risk of thunderstorms, risk of extreme gusts, risk of wind direction changes, gust amplitudes.

15. The wind turbine of claim 1 wherein the controller receives the weather forecast information and/or the data from the sensing apparatus periodically.

16. The wind turbine of claim 1, after the controller reduces the extent to which the wind turbine is run in the over-rated mode of operation, the controller waits for a predetermined period of time.

17. The wind turbine of claim 1 wherein the wind turbine is part of a wind power plant.

18. The wind turbine of claim 17, wherein a common controller is used to control the extent to which each of a plurality of wind turbines is run in the over-rated mode of operation.

19. A method of controlling a wind turbine, the wind turbine having a rated power output and an over-rated mode of operation during which one or more operating parameters are adjusted to allow the wind turbine to generate power greater than the rated power, the method comprising:
receiving weather forecast information and determining if the weather forecast information indicates a risk of turbulent operating conditions;
controlling the wind turbine to operate in the over-rated mode of operation by adjusting at least one of the operating parameters when the determination does not indicate turbulent conditions; and
reducing the extent to which the wind turbine is run in the over-rated mode by adjusting at least one of the operating parameters when the determination indicates turbulent conditions.

20. A computer readable medium on which one or more instructions are stored for controlling the controller of a wind turbine, the wind turbine having a rated power output and an over-rated mode of operation during which one or more operating parameters are adjusted to allow the wind turbine to generate power greater than the rated power, wherein when the one or more instructions are carried out by the controller of the wind turbine, the wind turbine is controlled to:
receive weather forecast information and determining if the weather forecast information indicates a risk of turbulent operating conditions;
control the wind turbine to operate in the over-rated mode of operation by adjusting at least one of the operating parameters when the determination does not indicate turbulent conditions; and
reduce the extent to which the wind turbine is run in the over-rated mode by adjusting at least one of the operating parameters when the determination indicates turbulent conditions.
